(19) United States
(12) Patent Application Publication
(10) Pub. No.: US 2024/0334220 A1
(43) Pub. Date: Oct. 3, 2024

(54) CROSS-LINK INTERFERENCE MEASUREMENT

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Tao LUO, San Diego, CA (US)

(21) Appl. No.: 18/438,318

(22) Filed: Feb. 9, 2024

Related U.S. Application Data
(60) Provisional application No. 63/493,506, filed on Mar. 31, 2023.

(51) Int. Cl. H04W 24/08; H04L 5/14

(52) U.S. Cl. CPC H04W 24/08; H04L 5/14

(57) ABSTRACT

Various aspects of the present disclosure generally relate to wireless communication. In some aspects, a user equipment (UE) may receive a cross-link interference measurement resource configuration that indicates a granularity for measuring one or more reference signals. The UE may receive cross-link interference associated with a transmission by another UE within an uplink sub-band of a sub-band full-duplex (SBFD) resource. The UE may measure, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource. Numerous other aspects are described.

### CROSS-REFERENCE TO RELATED APPLICATION

This Patent application claims priority to U.S. Provisional Patent Application No. 63/493,506, filed on Mar. 31, 2023, entitled “CROSS-LINK INTERFERENCE MEASUREMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for cross-link interference measurement.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example relating to cross-link interference detection and mitigation, in accordance with the present disclosure.

FIG. 5 is a diagram illustrating examples of full-duplex communication in a wireless network, in accordance with the present disclosure.

FIGS. 6A-6C are diagrams illustrating examples of cross-link interference in sub-band full-duplex communications, in accordance with the present disclosure.

FIG. 7 is a diagram illustrating an example of cross-link interference measurement, in accordance with the present disclosure.

FIG. 8 is a diagram illustrating an example of a granularity for measuring a reference signal strength indicator within a downlink sub-band, in accordance with the present disclosure.

FIG. 9 is a diagram illustrating an example of a granularity for measuring a reference signal strength indicator within an uplink sub-band, in accordance with the present disclosure.

FIG. 10 is a diagram illustrating examples of granularities for measuring a reference signal strength indicator within an uplink sub-band, in accordance with the present disclosure.

FIG. 11 is a diagram illustrating an example of sub-bands within a sub-band full-duplex resource, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### SUMMARY

Some aspects described herein relate to a method of wireless communication performed by a user equipment (UE). The method may include receiving a cross-link interference measurement resource configuration that indicates a granularity for measuring one or more reference signals. The method may include receiving cross-link interference associated with a transmission by another UE within an uplink sub-band of a sub-band full-duplex (SBFD) resource. The method may include measuring, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource.

Some aspects described herein relate to a method of wireless communication performed by a network node. The method may include transmitting a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource.

Some aspects described herein relate to an apparatus for wireless communication at a UE. The apparatus may include a memory and one or more processors coupled to the memory. The one or more processors may be configured to receive a cross-link interference measurement resource configuration that indicates a granularity for measuring one or more reference signals. The one or more processors may be configured to receive cross-link interference associated with a transmission by another UE within an uplink sub-band of an SBFD resource. The one or more processors may be configured to measure, in accordance with the granularity, at least one of an RSSI within a downlink sub-band of the SBFD resource, an RSSI within an uplink sub-band of the SBFD resource, or an RSRP within the uplink sub-band of the SBFD resource.

Some aspects described herein relate to an apparatus for wireless communication at a network node. The apparatus may include a memory and one or more processors coupled to the memory. The one or more processors may be configured to transmit a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource.

Some aspects described herein relate to a non-transitory computer-readable medium that stores a set of instructions for wireless communication by a UE. The set of instructions, when executed by one or more processors of the UE, may cause the UE to receive a cross-link interference measurement resource configuration that indicates a granularity for measuring one or more reference signals. The set of instructions, when executed by one or more processors of the UE, may cause the UE to receive cross-link interference associated with a transmission by another UE within an uplink sub-band of an SBFD resource. The set of instructions, when executed by one or more processors of the UE, may cause the UE to measure, in accordance with the granularity, at least one of an RSSI within a downlink sub-band of the SBFD resource, an RSSI within an uplink sub-band of the SBFD resource, or an RSRP within the uplink sub-band of the SBFD resource.

Some aspects described herein relate to a non-transitory computer-readable medium that stores a set of instructions for wireless communication by a network node. The set of instructions, when executed by one or more processors of the network node, may cause the network node to transmit a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource.

Some aspects described herein relate to an apparatus for wireless communication. The apparatus may include means for receiving a cross-link interference measurement resource configuration that indicates a granularity for measuring one or more reference signals. The apparatus may include means for receiving cross-link interference associated with a transmission by a UE within an uplink sub-band of an SBFD resource. The apparatus may include means for measuring, in accordance with the granularity, at least one of an RSSI within a downlink sub-band of the SBFD resource, an RSSI within an uplink sub-band of the SBFD resource, or an RSRP within the uplink sub-band of the SBFD resource.

Some aspects described herein relate to an apparatus for wireless communication. The apparatus may include means for transmitting a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

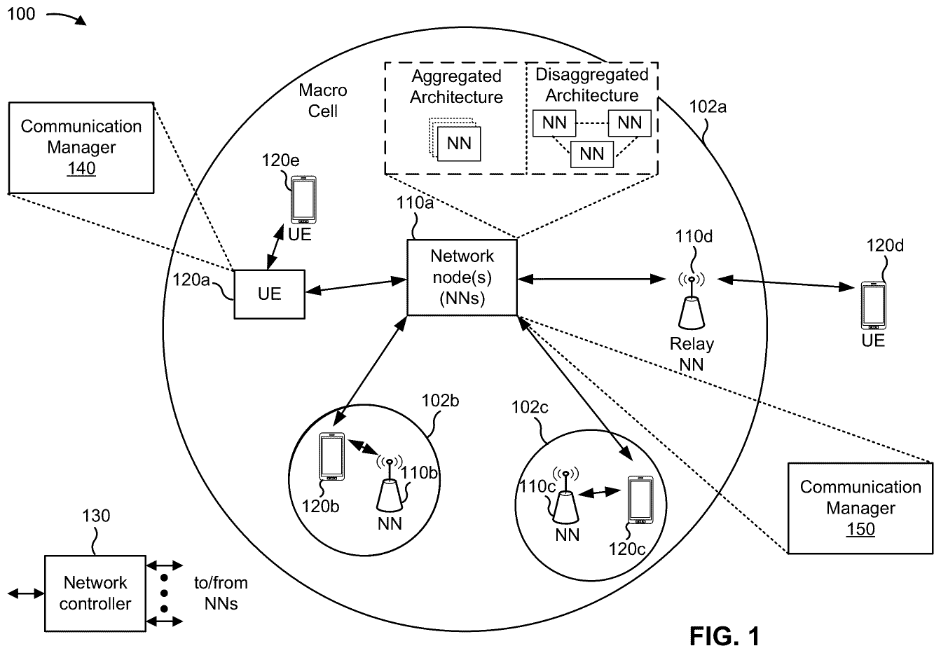

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a cross-link interference measurement resource configuration that indicates a granularity for measuring one or more reference signals; receive cross-link interference associated with a transmission by another UE within an uplink sub-band of a sub-band full-duplex (SBFD) resource; and measure, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource. Additionally, or alternatively, the communication manager 140 may perform one or more other operations described herein.

In some aspects, the network node 110 may include a communication manager 150. As described in more detail elsewhere herein, the communication manager 150 may transmit a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource. Additionally, or alternatively, the communication manager 150 may perform one or more other operations described herein.

As indicated above, FIG. 1 is provided as an example. Other examples may differ from what is described with regard to FIG. 1.

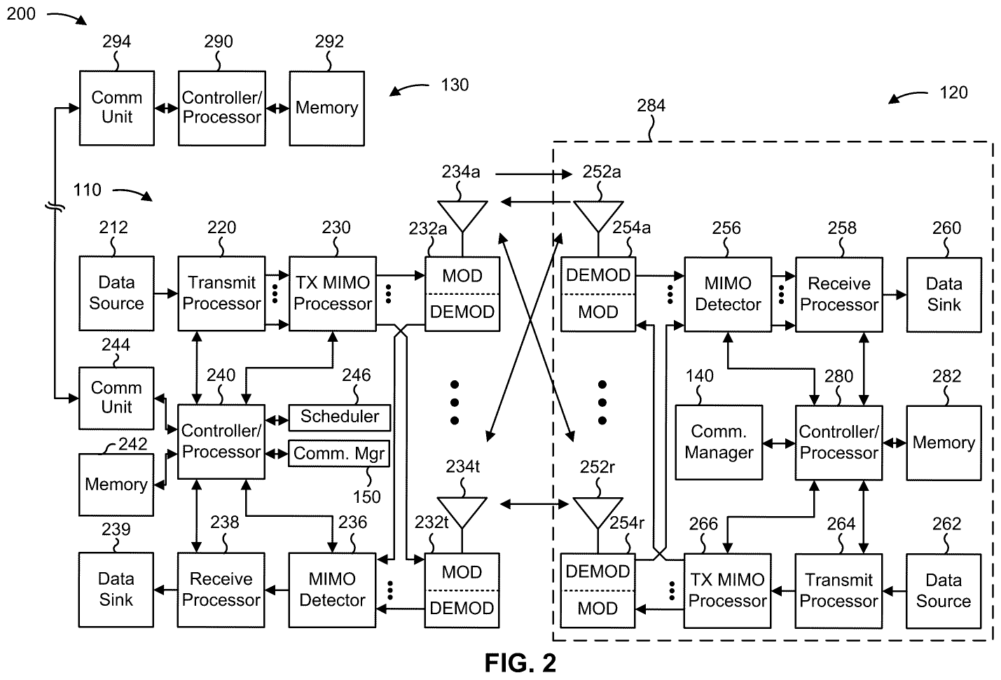

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

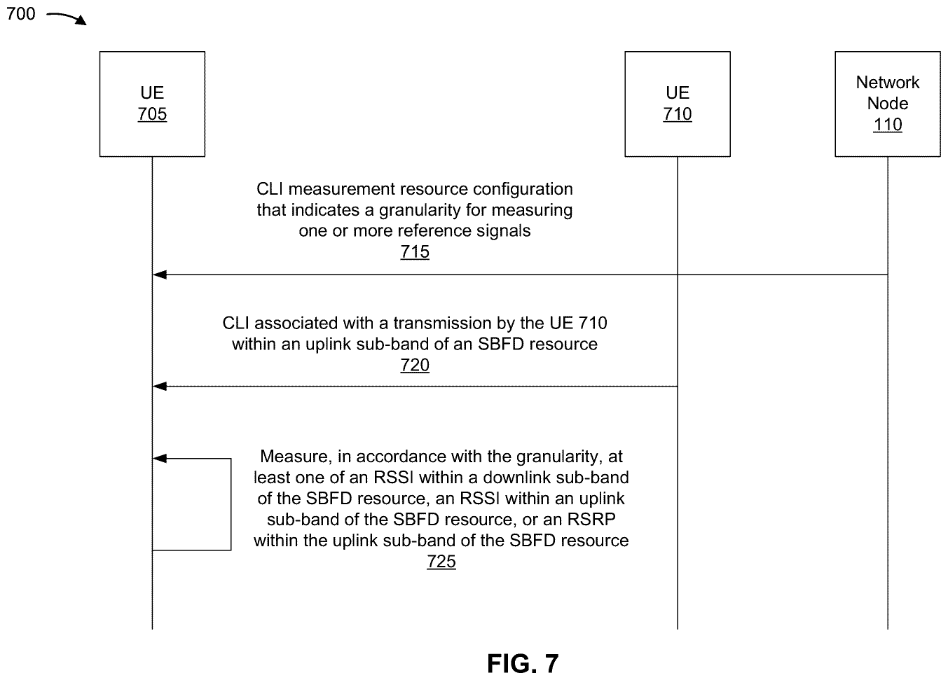

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

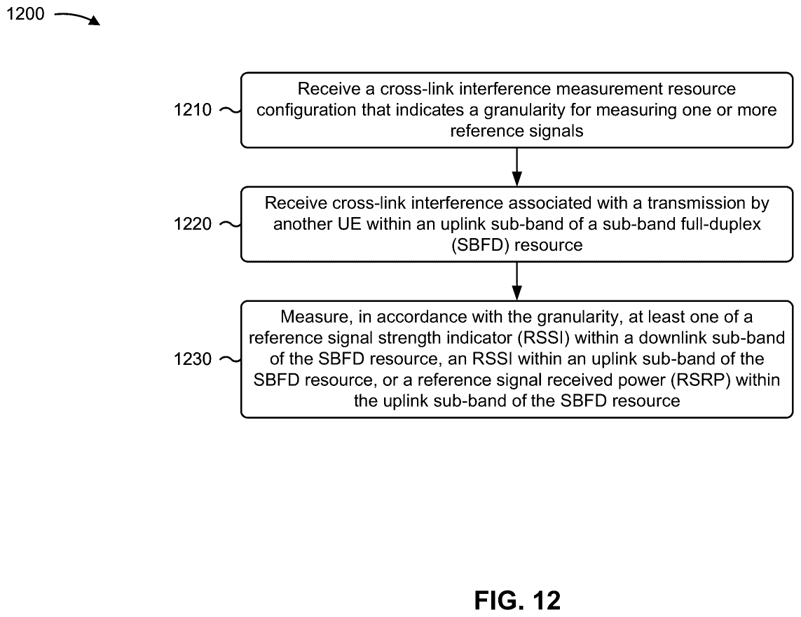

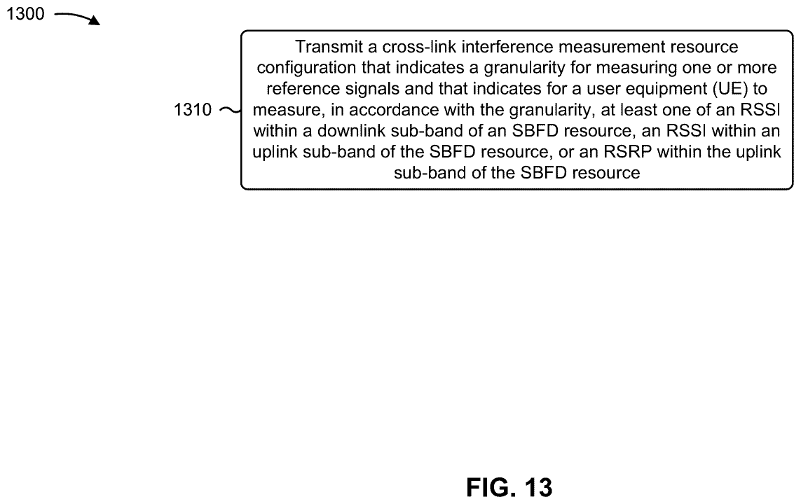

The controller/processor 240 of the network node 110, the controller/processor 280 of the UE 120, and/or any other component(s) of FIG. 2 may perform one or more techniques associated with cross-link interference (CLI) measurement, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving a cross-link interference measurement resource configuration that indicates a granularity for measuring one or more reference signals; means for receiving cross-link interference associated with a transmission by another UE within an uplink sub-band of an SBFD resource; and/or means for measuring, in accordance with the granularity, at least one of an RSSI within a downlink sub-band of the SBFD resource, an RSSI within an uplink sub-band of the SBFD resource, or an RSRP within the uplink sub-band of the SBFD resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

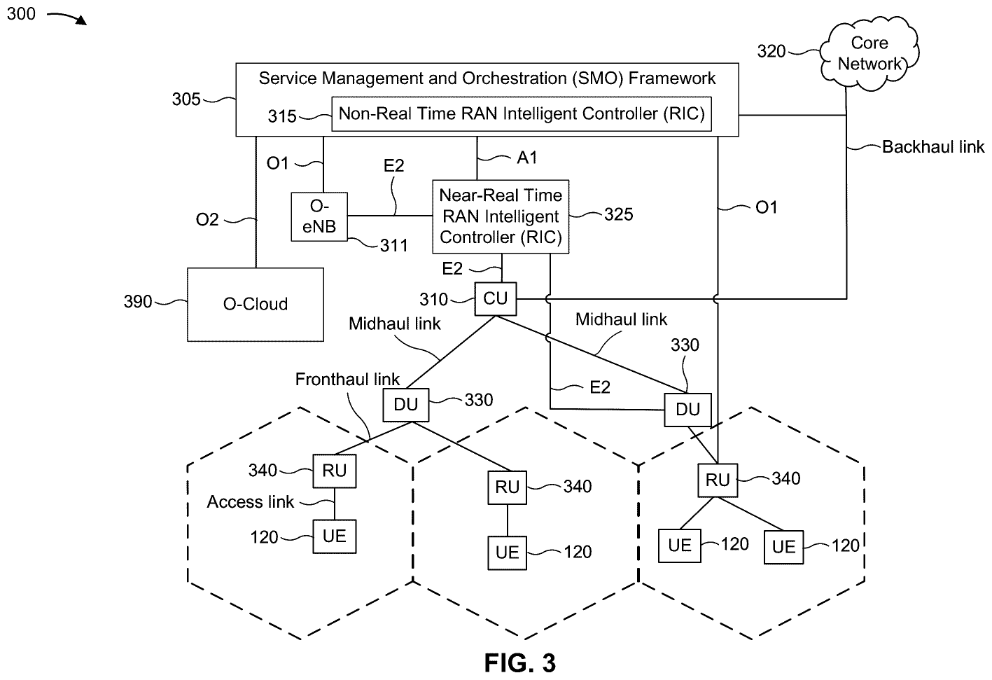

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

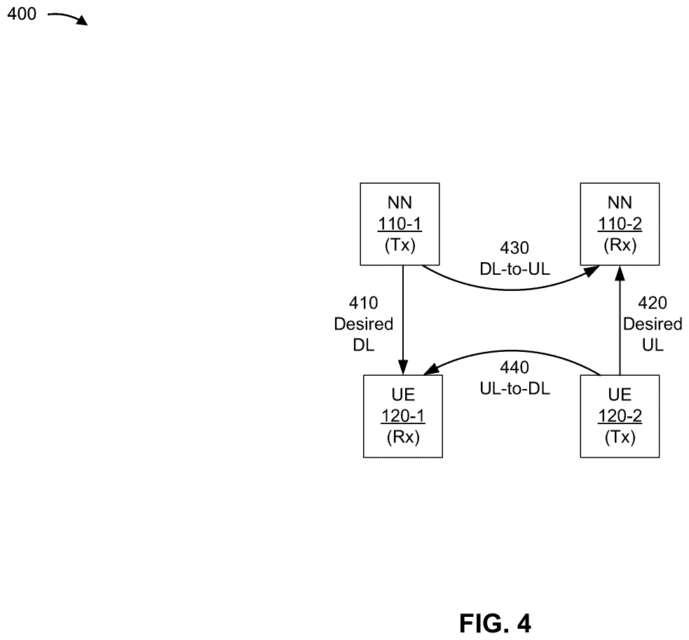

FIG. 4 is a diagram illustrating an example 400 relating to cross-link interference detection and mitigation, in accordance with the present disclosure.

In dynamic time division duplexing (TDD), the allocation of network resources to uplink and downlink may be dynamically modified depending on a traffic load. For example, a network node (NN) 110 may configure a TDD configuration (e.g., a TDD pattern) with more uplink transmission time intervals (TTIs) (e.g., frames, subframes, slots, mini-slots, and/or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 and the UE 120.

As shown in FIG. 4, when neighboring network nodes 110 use different TDD configurations to communicate with UEs 120, this may result in a downlink communication 410 between a first network node 110-1 and a first UE 120-1 in a same TTI as an uplink communication 420 between a second network node 110-2 and a second UE 120-2. These communications in different transmission directions (e.g., downlink vs. uplink) in the same TTI may interfere with one another, which may be referred to as cross-link interference.

For example, as shown by reference number 430, the downlink communication 410 transmitted by the first network node 110-1 may be received by the second network node 110-2, and may interfere with reception, by the second network node 110-2, of the uplink communication 420 from the second UE 120-2. This may be referred to as downlink-to-uplink (DL-to-UL) interference, network node to network node interference, or gNB-to-gNB interference.

Further, as shown by reference number 440, the uplink communication 420 transmitted by the second UE 120-2 may be received by the first UE 120-1, and may interfere with reception, by the first UE 120-1, of the downlink communication 410 from the first network node 110-1. This may be referred to as uplink-to-downlink (UL-to-DL) interference or UE-to-UE interference. This UE to UE interference may occur and/or may increase when the first UE 120-1 and the second UE 120-2 are in close proximity, and may be avoided or mitigated by preventing scheduling of the UEs 120 in different transmission directions in the same TTI.

As indicated above, FIG. 4 is provided as an example. Other examples are possible and may differ from what was described with respect to FIG. 4.

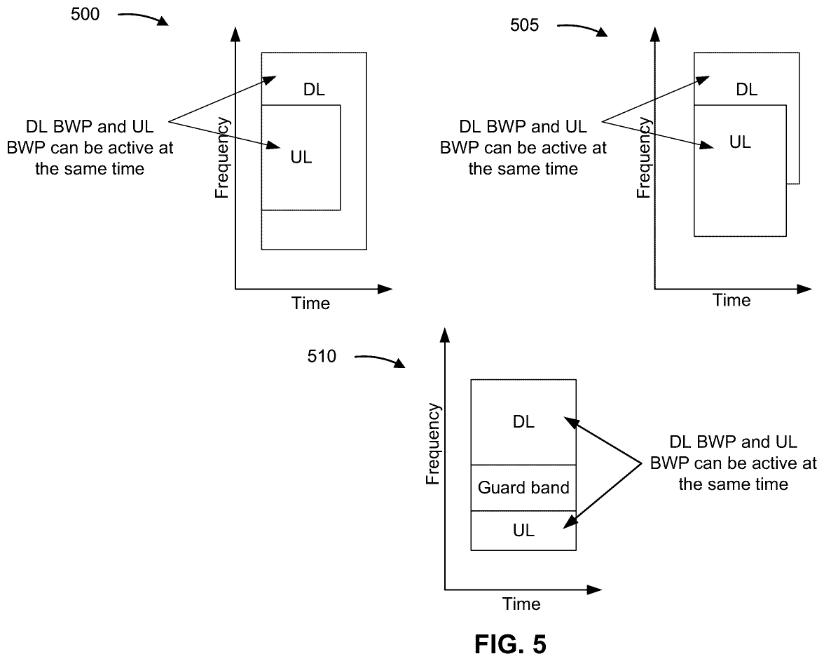

FIG. 5 is a diagram illustrating examples 500, 505, and 510 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 5, examples 500 and 505 show examples of in-band full-duplex (IBFD) communication. In IBFD, a UE may transmit an uplink communication to a network node and receive a downlink communication from the network node on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

In some cases, SBFD communications performed using a time domain duplex (TDD) carrier or intra-band carrier aggregation (CA) may increase an uplink duty cycle, which may lead to latency reduction. For example, it may be possible to transmit uplink signals in an uplink sub-band in downlink only slots or flexible slots, or to receive downlink signals in downlink sub-bands in uplink only slots, which may enable latency savings. Additionally, or alternatively, uplink coverage may be improved. In some cases, the increased uplink duty cycle may result in enhanced system capacity, resource utilization, and/or spectrum efficiency. In some cases, the increased uplink duty cycle may enable flexible and dynamic uplink or downlink resource adaptation according to uplink or downlink traffic in a robust manner.

As indicated above, FIG. 5 is provided as an example. Other examples may differ from what is described with respect to FIG. 5.

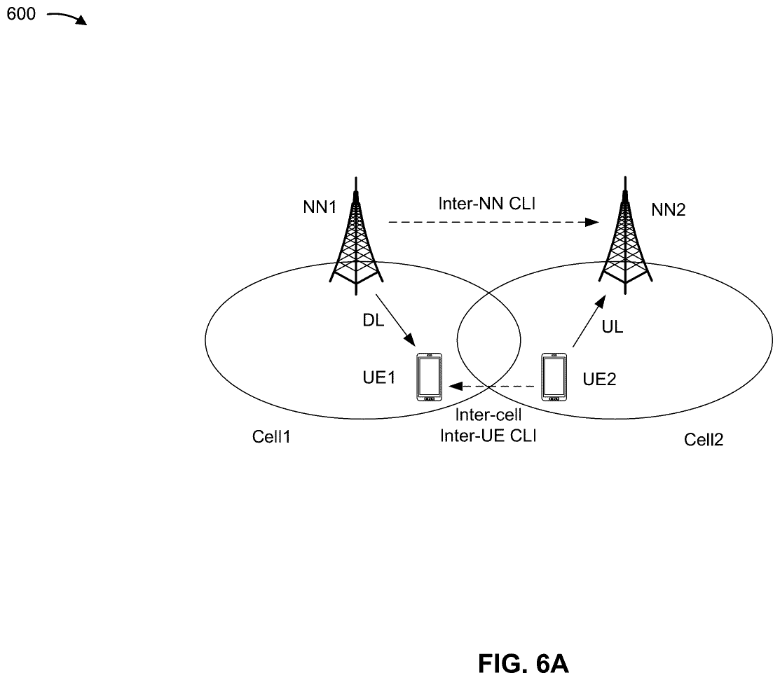

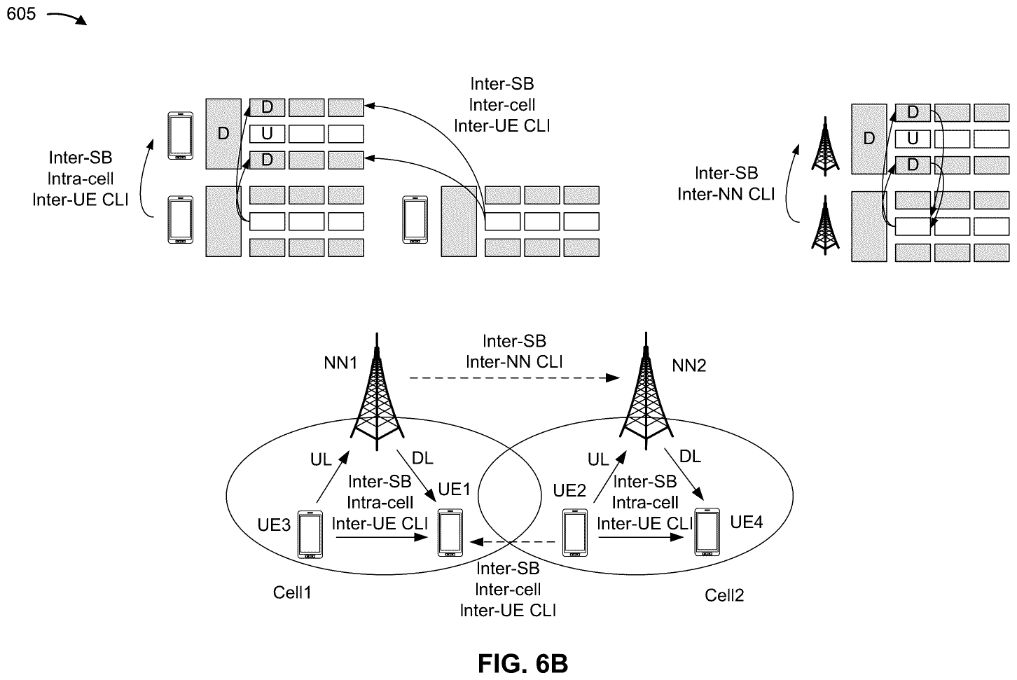

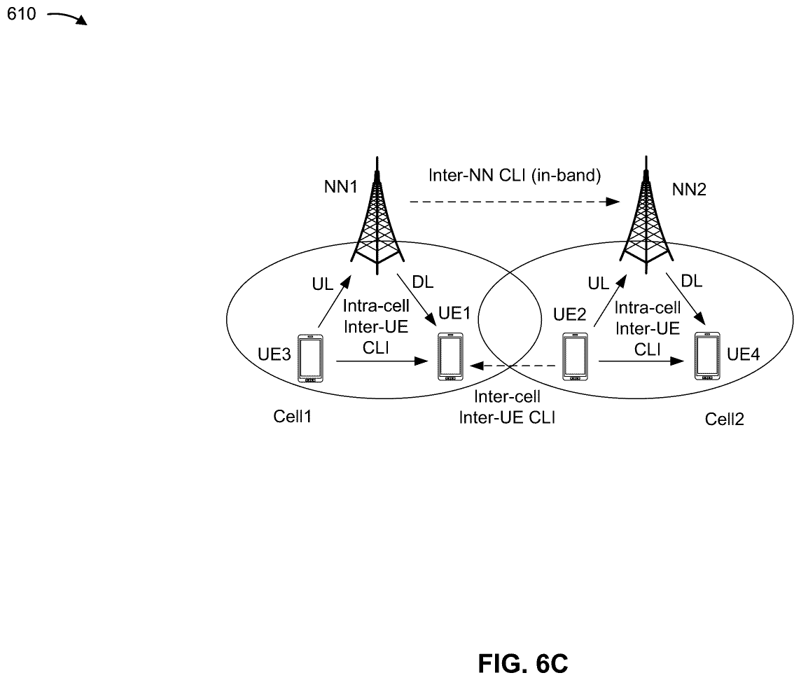

FIGS. 6A-6C are diagrams illustrating examples 600, 605, and 610 of cross-link interference in sub-band full-duplex communications, in accordance with the present disclosure. A UE (e.g., a victim UE) may experience CLI that is based at least in part on a transmission by another UE (e.g., an aggressor UE).

As shown in FIG. 6A and the example 600, CLI may occur in a TDD scenario. A first UE (UE1) located within a first cell (cell1) may communicate with a second UE (UE2) located within a second cell (cell2). A first network node (NN1) located within cell1 may communicate with a second network node (NN2) within cell2. UE1 may receive a downlink communication from NN1. UE2 may transmit an uplink communication to NN2. UE1 (victim UE) may experience CLI based at least in part on the uplink transmission by UE2 (aggressor UE). This may be referred to as inter-cell inter-UE CLI. NN2 (victim NN) may experience CLI based at least in part on the downlink transmission by NN1 (aggressor NN). This may be referred to as inter-NN CLI.

As shown in FIG. 6B and the example 605, CLI may occur in an SBFD scenario. UE1 may receive a downlink communication from NN1. UE1 may receive a sidelink communication from a third UE (UE3) located in cell1. UE3 may transmit an uplink communication to NN1. UE2 may transmit an uplink communication to NN2. UE2 may receive a sidelink communication from a fourth UE (UE4) located in cell2. UE4 may receive a downlink communication from NN2. UE1 may experience inter-sub-band (inter-SB) inter-cell inter-UE CLI based at least in part on the uplink transmission by UE2. The inter-SB inter-cell inter-UE CLI may occur based at least in part on the UE2 performing an uplink transmission using a downlink sub-band. UE1 may experience inter-SB intra-cell inter-UE CLI based at least in part on the uplink transmission by UE3. The inter-SB intra-cell inter-UE CLI may occur based at least in part on UE3 performing an uplink transmission using a downlink sub-band. UE4 may experience inter-SB intra-cell inter-UE CLI based at least in part on the uplink transmission by UE2. The inter-SB intra-cell inter-UE CLI may occur based at least in part on UE2 performing an uplink transmission using a downlink sub-band. NN2 may experience inter-SB inter-NN CLI based at least in part on the downlink transmission by NN1.

As shown in FIG. 6C and the example 610, CLI may occur in a partially overlapped or a fully overlapped full-duplex scenario. UE1 may receive a downlink communication from NN1. UE1 may receive a sidelink communication from UE3. UE3 may transmit an uplink communication to NN1. UE2 may transmit an uplink communication to NN2. UE2 may receive a sidelink communication from UE4. UE4 may receive a downlink communication from NN2. UE1 may experience inter-cell inter-UE CLI based at least in part on the uplink transmission by UE2. UE1 may experience intra-cell inter-UE CLI based at least in part on the uplink transmission by UE3. UE4 may experience intra-cell inter-UE CLI based at least in part on the uplink transmission by UE2. NN2 may experience inter-NN CLI (in-band) based at least in part on the downlink transmission by NN1.

As described herein, a victim UE may receive inter-UE CLI associated with an uplink transmission by an aggressor UE. The inter-UE CLI may be intra-cell CLI based at least in part on the victim UE and the aggressor UE being located in the same cell, or may be inter-cell CLI based at least in part on the victim UE and the aggressor UE being located in different cells. Additionally, or alternatively, the inter-UE CLI may be intra-SB CLI based at least in part on the victim UE receiving and the aggressor UE transmitting within a same sub-band, or may be inter-SB CLI based at least in part on the victim UE receiving within a first sub-band and the aggressor UE transmitting within a second sub-band. The victim UE may be configured to perform one or more reference signal measurements associated with the CLI. However, the victim UE may not be configured with information that enables the victim UE to measure RSSI or RSRP for inter-UE inter-SB CLI. For example, the victim UE may not be configured with a granularity for performing the RSSI or RSRP measurements associated with the inter-UE inter-SB CLI. In some cases, the victim UE may not be configured to measure RSSI within a downlink sub-band, measure RSSI within an uplink sub-band, or measure RSRP within an uplink sub-band, for inter-UE inter-SB CLI in accordance with the granularity, among other examples.

Techniques and apparatuses are described herein for CLI measurement. A network node may transmit, and a victim UE may receive, a CLI measurement resource configuration that indicates a granularity for measuring one or more reference signals. The victim UE may receive CLI associated with a transmission by an aggressor UE within an uplink sub-band of the SBFD resource. The victim UE may measure, in accordance with the granularity, at least one of an RSSI within a downlink sub-band of the SBFD resource, an RSSI within an uplink sub-band of the SBFD resource, or an RSRP within an uplink sub-band of the SBFD resource. This may enable the victim UE to perform RSSI or RSRP measurements for inter-UE inter-SB CLI. Additional details are described herein.

As indicated above, FIGS. 6A-6C are provided as examples. Other examples may differ from what is described with respect to FIGS. 6A-6C.

FIG. 7 is a diagram illustrating an example 700 of cross-link interference measurement, in accordance with the present disclosure. A UE 705 may communicate with a UE 710 and the network node 110. The UE 705 may be a victim UE and the UE 710 may be an aggressor UE.

As shown by reference number 715, the network node 110 may transmit, and the UE 705 may receive, a CLI measurement resource configuration. The CLI measurement resource configuration may indicate a granularity for measuring one or more reference signals. The granularity may be a frequency resource granularity. For example, the granularity may indicate one or more frequency resource portions of the sub-band within which reference signal measurements are to be performed. In one example, a first granularity may indicate for the UE 705 to perform a measurement within the sub-band, and a second granularity may indicate for the UE 705 to perform a first measurement within a first frequency resource portion (such as a lower CLI portion) of the sub-band and to perform a second measurement within a second frequency resource portion (such as a higher CLI portion) of the sub-band. In some aspects, the CLI measurement resource configuration may indicate for the UE 705 to measure an RSSI within a downlink sub-band of the SBFD resource, to measure an RSSI within an uplink sub-band of the SBFD resource, and/or to measure an RSRP within an uplink sub-band of the SBFD resource.

As shown by reference number 720, the UE 705 may receive CLI associated with a transmission by the UE 710 within an uplink sub-band of the SBFD resource. For example, the UE 710 may perform an uplink transmission to the network node 110 within the uplink sub-band of the SBFD resource, and the UE 705 may receive CLI based at least in part on the uplink transmission by the UE 710.

As shown by reference number 725, the UE 705 may measure the RSSI within the downlink sub-band of the SBFD resource, the RSSI within the uplink sub-band of the SBFD resource, and/or the RSRP within the uplink sub-band of the SBFD resource. In some aspects, the UE may measure, in accordance with the granularity, the RSSI within the downlink sub-band of the SBFD resource, the RSSI within the uplink sub-band of the SBFD resource, and/or the RSRP within the uplink sub-band of the SBFD resource.

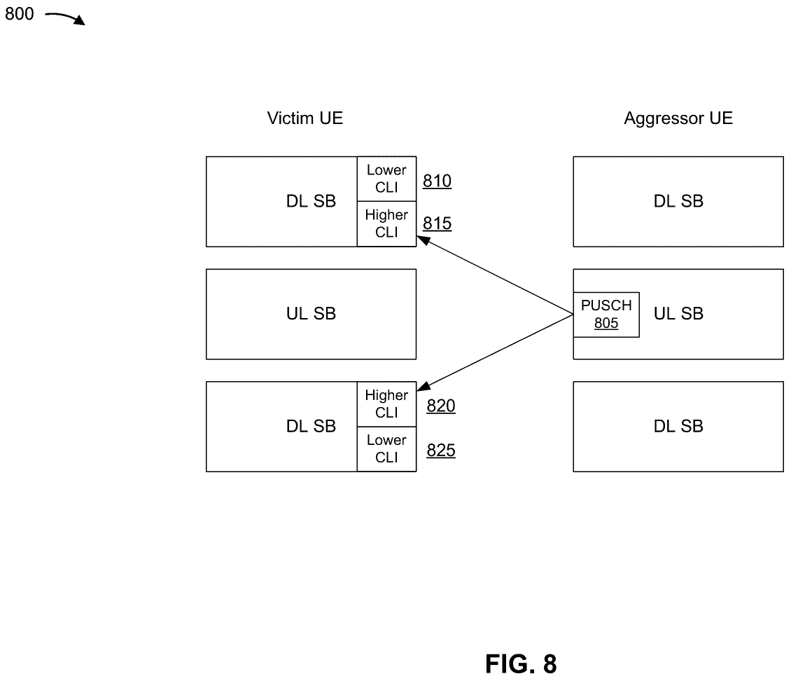

In some aspects, the UE 705 may be configured to measure the RSSI within the downlink sub-band of the SBFD resource. In a first example, the UE 705 may measure and report the RSSI for each downlink sub-band (e.g., per downlink sub-band) of an SBFD resource that includes two downlink sub-bands and an uplink sub-band between the two downlink sub-bands. In a second example, the UE 705 may measure and report a total RSSI across two sub-bands for an SBFD resource that includes two downlink sub-bands and an uplink sub-band between the two downlink sub-bands. In a third example, the UE 705 may be configured to measure and report the RSSI within the downlink sub-band in accordance with the granularity. For example, the granularity may indicate for the UE 705 to measure and report a higher CLI portion and a lower CLI portion within the downlink sub-bands of the SBFD resource. The UE 705 may measure and report, in accordance with the granularity, the higher CLI portion and the lower CLI portion within the downlink sub-bands of the SBFD resource. Additional details regarding these features are described in connection with FIG. 8. In some aspects, due to frequency selectivity and transmission frequency resources that are close to the lower or upper frequency resources of the uplink sub-band, the CLI may be different on different (e.g., narrower) frequency resources within each downlink sub-band. In some aspects, the network node 110 may configure the UE 705 to report upper edge, center, and lower edge frequency resources within each downlink sub-band of the SBFD resource. The UE 705 may report the upper, center, and lower edge frequency resources within each downlink sub-band of the SBFD resource in accordance with the configuration. In some aspects, the UE 705 may be configured to report in accordance with a megahertz interval or a resource block interval within the downlink sub-band of the SBFD resource. In one example, if the downlink sub-band is configured as 40 MHZ or with 104 resource blocks, the network node 110 may configure the UE 705 to report, for example, every 10 MHz or every 20 resource blocks within the downlink sub-band.

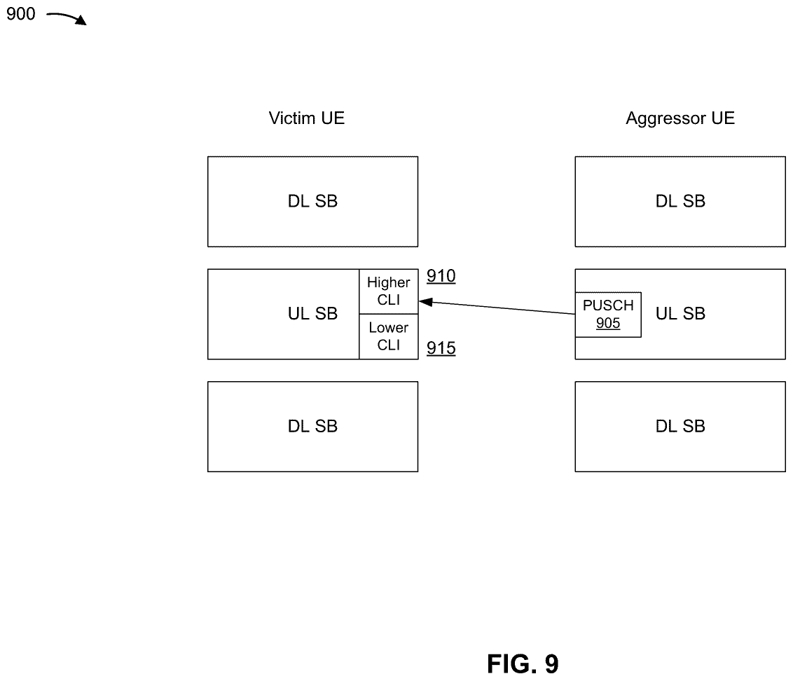

In some aspects, the UE 705 may be configured to measure the RSSI and/or the RSRP within the uplink sub-band of the SBFD resource. In a first example, the UE 705 may measure and report the RSSI and/or the RSRP within the uplink sub-band of the SBFD resource in accordance with the granularity. For example, the UE 705 may measure and report, in accordance with the granularity, a higher CLI portion and a lower CLI portion within the uplink sub-band of the SBFD resource. Additional details regarding these features are described in connection with FIG. 9. In some aspects, due to frequency selectivity and transmission frequency resources that are close to the lower or upper frequency resources of the uplink sub-band, the CLI may be different on different (e.g., narrower) frequency resources within the uplink sub-band. In some aspects, the network node 110 may configure the UE 705 to report upper edge, center, and lower edge frequency resources within the uplink sub-band. The UE 705 may report the upper, center, and lower edge frequency resources within the downlink sub-band of the SBFD resource in accordance with the configuration. In some aspects, the UE 705 may be configured to report in accordance with a megahertz interval or a resource block interval within the uplink sub-band of the SBFD resource. In one example, if the uplink sub-band is configured as 20 MHz or with 55 resource blocks, the network node 110 may configure the UE 705 to report, for example, every 10 MHz or every 20 resource blocks within the uplink sub-band.

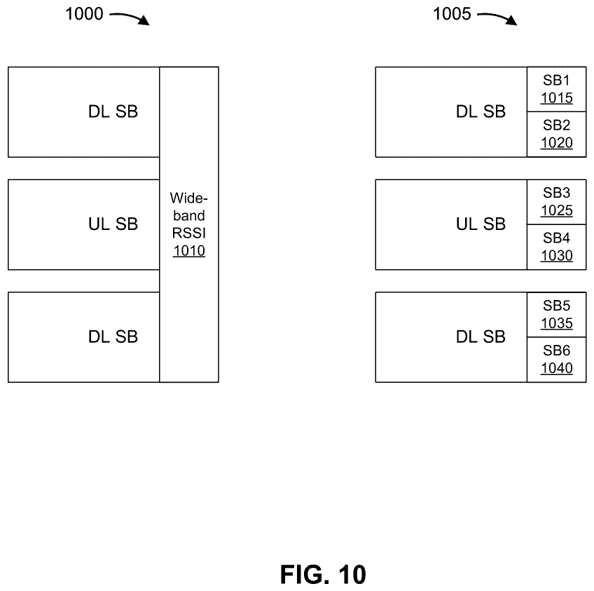

In some aspects, the measurement resource configuration may configure the UE 705 to perform a single measurement and to report a total RSSI across all downlink sub-bands and all uplink sub-bands within the SBFD resource. The UE 705 may perform the measurement and report the total RSSI across all of the downlink sub-bands and all of the uplink sub-bands within the SBFD resource in accordance with the measurement resource configuration. In some aspects, the measurement resource configuration may configure the UE 705 to perform two or more RSSI measurements (per sub-band) within the downlink sub-bands and the uplink sub-band. The UE 705 may perform two or more RSSI measurements within the downlink sub-band(s) and may perform two or more RSSI measurements within the uplink sub-band, and may report the RSSI measurements in accordance with the measurement resource configuration. Additional details regarding these features are described in connection with FIG. 10.

In some aspects, the uplink sub-band may receive resources associated with all uplink sub-bands in any SBFD symbol or slot. A fixed rule or configuration (by the network node 110) may enable CLI reception within the uplink sub-band. Other uplink transmissions, such as sounding reference signal (SRS), configured grant (CG), or physical uplink control channel (PUCCH) transmissions, among other examples, may be dropped in accordance with the rule or configuration. In some aspects, the uplink sub-band may receive resources for all uplink sub-bands in certain SBFD symbols or slots, such as one or more select SBFD symbols or slots. A fixed rule or configuration (by the network node 110) may enable CLI reception within the uplink sub-band in the one or more select SBFD symbols or slots without (pre-)configured SRS or PUCCH transmissions and/or without higher priority uplink transmissions. (Pre-)configured uplink transmissions having a lower priority, such as CG and physical uplink shared channel (PUSCH) transmissions, among other examples, may be dropped in accordance with the rule or configuration.

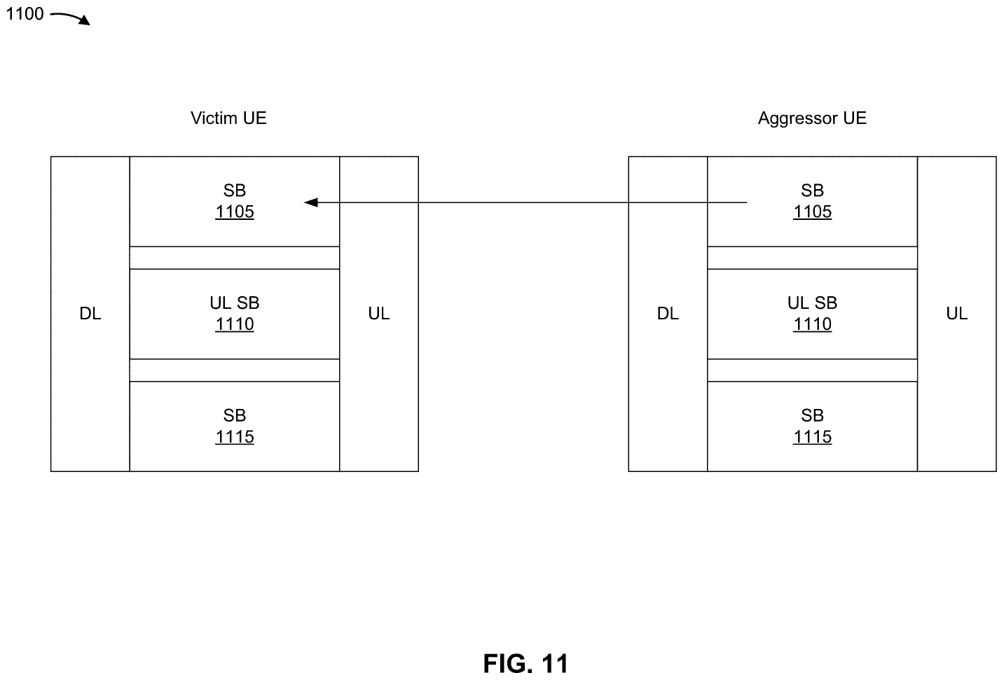

In some aspects, the SBFD resource may include an uplink sub-band and one or more other sub-bands that are outside of the uplink sub-band. For example, the SBFD resource may include a first sub-band, a second sub-band corresponding to an uplink sub-band, and a third sub-band. The first sub-band and the third sub-band may be used either for transmitting or receiving. The first sub-band and the third sub-band may be referred to as flexible sub-bands. In some aspects, the SBFD resource may be configured on a flexible symbol or slot. In some aspects, the UE 705 may be configured to measure the RSSI or RSRP within the one or more sub-bands that are outside of the uplink sub-band. For example, the UE 705 may measure RSSI or RSRP within the one or more flexible sub-bands. Additional details regarding these features are described in connection with FIG. 11.

In some aspects, the RSSI or RSRP (sub-band or wideband) measurements may be applicable whether the CLI is associated with a Layer 1 (L1), Layer 2 (L2), or Layer 3 (L3) reporting framework. For example, the RSSI or RSRP measurements may be applicable based at least in part on the CLI being associated with an L1 reporting framework. Additionally, or alternatively, the RSSI or RSRP measurements may be applicable based at least in part on the CLI being associated with an L2 reporting framework. Additionally, or alternatively, the RSSI or RSRP measurements may be applicable based at least in part on the CLI being associated with an L3 reporting framework.

In some aspects, the sub-band CLI measurement may be configured using an RRC parameter. In some aspects, the RRC parameter may indicate which sub-bands are to be measured and reported in a report configuration. In some aspects, the RRC parameter may include a bitmap, where each bit in the bitmap corresponds to a sub-band. A first state of a bit may indicate that a sub-band is to be measured and reported, and a second state of the bit may indicate that the sub-band is not to be measured and reported. In some aspects, the RRC parameter may indicate the granularity. The granularity may be based at least in part on the UE downlink bandwidth-part (BWP) size or may be based at least in part on the UE downlink BWP size and the downlink sub-band size for SBFD. For example, the granularity may be larger for wider BWPs or downlink sub-bands. In some aspects, if the RRC parameter is not configured, the default measurements may be wideband CLI measurements. For example, the UE 705 may perform wideband CLI measurements based at least in part on not being configured with the RRC parameter.

As indicated above, FIG. 7 is provided as an example. Other examples may differ from what is described with respect to FIG. 7.

FIG. 8 is a diagram illustrating an example 800 of a granularity for measuring RSSI within a downlink sub-band, in accordance with the present disclosure. As described herein, a victim UE may be configured to measure and report RSSI within one or more downlink sub-bands of an SBFD resource in accordance with a granularity. An aggressor UE may perform an uplink transmission using a PUSCH 805. A measurement resource configuration that includes the granularity may indicate for the victim UE to measure and report RSSI within a lower CLI portion 810 of a first downlink sub-band and to measure and report RSSI within a higher CLI portion 815 of the first downlink sub-band. Additionally, or alternatively, the measurement resource configuration that includes the granularity may indicate for the victim UE to measure and report RSSI within a higher CLI portion 820 of a second downlink sub-band and to measure and report RSSI within a lower CLI portion 825 of the second downlink sub-band. The victim UE may perform the one or more measurements in accordance with the measurement resource configuration and the granularity.

As indicated above, FIG. 8 is provided as an example. Other examples may differ from what is described with respect to FIG. 8.

FIG. 9 is a diagram illustrating an example 900 of a granularity for measuring RSSI within an uplink sub-band, in accordance with the present disclosure. As described herein, a victim UE may be configured to measure and report RSSI and/or RSRP within an uplink sub-band of an SBFD resource in accordance with a granularity. An aggressor UE may perform an uplink transmission using a PUSCH 905. A measurement resource configuration that includes the granularity may indicate for the victim UE to measure and report RSSI and/or RSRP within a higher CLI portion 910 of the uplink sub-band and to measure and report RSSI and/or RSRP within a lower CLI portion 915 of the uplink sub-band. The victim UE may perform the one or more measurements in accordance with the measurement resource configuration and the granularity.

As indicated above, FIG. 9 is provided as an example. Other examples may differ from what is described with respect to FIG. 9.

FIG. 10 is a diagram illustrating examples 1000 and 1005 of granularities for measuring RSSI within an uplink sub-band, in accordance with the present disclosure. As shown in the example 1000, a UE may perform a single measurement and report a single total RSSI across all downlink sub-bands and all uplink sub-bands within an SBFD resource. For example, the UE may measure a wideband RSSI 1010 and may report the wideband RSSI across all downlink sub-bands and all uplink sub-bands within the SBFD resource. As shown in the example 1005, the UE may perform two or more measurements within the sub-bands of the SBFD resource in accordance with a granularity. For example, the UE may perform a first measurement within SB1 1015 and a second measurement within SB2 1020 of a first downlink sub-band, a third measurement within SB3 1025 and a fourth measurement within SB4 1030 of an uplink sub-band, and a fifth measurement within SB5 1035 and a sixth measurement within SB6 1040 of a second downlink sub-band.

As indicated above, FIG. 10 is provided as an example. Other examples may differ from what is described with respect to FIG. 10.

FIG. 11 is a diagram illustrating an example 1100 of sub-bands within an SBFD resource, in accordance with the present disclosure. An SBFD resource may be configured with a first sub-band 1105, a second sub-band corresponding to an uplink sub-band 1110, and a third sub-band 1115. The first sub-band 1105 and the third sub-band 1115 may be located outside of the uplink sub-band 1110 and may be used for transmitting or receiving. The first sub-band 1105 and the third sub-band 1115 may be referred to as flexible sub-bands. In one example, an aggressor UE may perform an uplink transmission within the first sub-band 1105. A victim UE may receive CLI associated with the uplink transmission by the aggressor UE and may measure RSSI and/or RSRP within the first sub-band 1105.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with cross-link interference measurement.

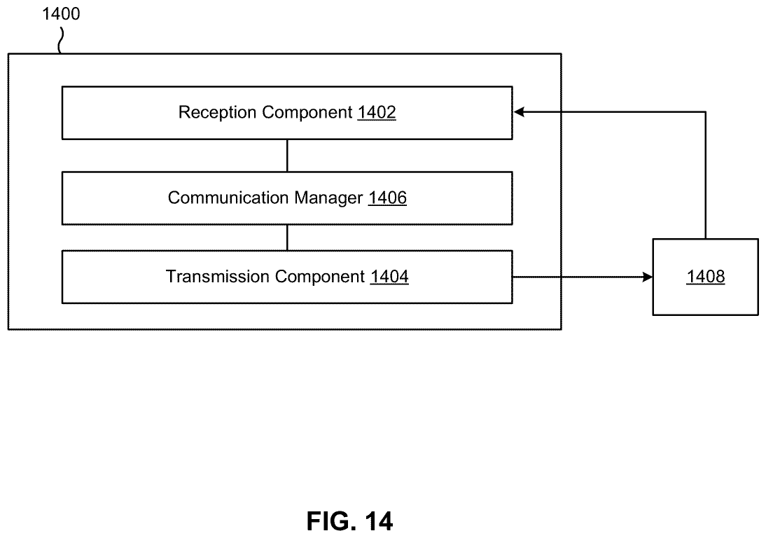

As shown in FIG. 12, in some aspects, process 1200 may include receiving a cross-link interference measurement resource configuration that indicates a granularity for measuring one or more reference signals (block 1210). For example, the UE (e.g., using reception component 1402 and/or communication manager 1406, depicted in FIG. 14) may receive a cross-link interference measurement resource configuration that indicates a granularity for measuring one or more reference signals, as described above.

As further shown in FIG. 12, in some aspects, process 1200 may include receiving cross-link interference associated with a transmission by another UE within an uplink sub-band of an SBFD resource (block 1220). For example, the UE (e.g., using reception component 1402 and/or communication manager 1406, depicted in FIG. 14) may receive cross-link interference associated with a transmission by another UE within an uplink sub-band of an SBFD resource, as described above.

As further shown in FIG. 12, in some aspects, process 1200 may include measuring, in accordance with the granularity, at least one of an RSSI within a downlink sub-band of the SBFD resource, an RSSI within an uplink sub-band of the SBFD resource, or an RSRP within the uplink sub-band of the SBFD resource (block 1230). For example, the UE (e.g., using communication manager 1406, depicted in FIG. 14) may measure, in accordance with the granularity, at least one of an RSSI within a downlink sub-band of the SBFD resource, an RSSI within an uplink sub-band of the SBFD resource, or an RSRP within the uplink sub-band of the SBFD resource, as described above.

Process 1200 may include additional aspects, such as any single aspect or any combination of aspects described below and/or in connection with one or more other processes described elsewhere herein.

In a first aspect, the SBFD resource includes two downlink sub-bands and an uplink sub-band that is between the two downlink sub-bands, wherein measuring the RSSI within the downlink sub-band of the SBFD resource comprises measuring the RSSI for each downlink sub-band of the SBFD resource, and wherein the method further comprises reporting the RSSI for each downlink sub-band of the SBFD resource.

In a second aspect, alone or in combination with the first aspect, the SBFD resource includes two downlink sub-bands and an uplink sub-band that is between the two downlink sub-bands, wherein measuring the RSSI within the downlink sub-band of the SBFD resource comprises measuring the RSSI across the two downlink sub-bands of the SBFD resource, and wherein the method further comprises reporting the RSSI across the two downlink sub-bands of the SBFD resource.

In a third aspect, alone or in combination with one or more of the first and second aspects, measuring the RSSI within the downlink sub-band of the SBFD resource comprises performing, in accordance with the granularity, a first RSSI measurement within a first frequency resource portion of the downlink sub-band of the SBFD resource and a second RSSI measurement within a second frequency resource portion of the downlink sub-band of the SBFD resource.

In a fourth aspect, alone or in combination with one or more of the first through third aspects, process 1200 includes reporting an upper edge frequency resource, a center frequency resource, and a lower edge frequency resource within each downlink sub-band of the SBFD resource.

In a fifth aspect, alone or in combination with one or more of the first through fourth aspects, process 1200 includes reporting in accordance with a megahertz interval or a resource block interval within the downlink sub-band of the SBFD resource.

In a sixth aspect, alone or in combination with one or more of the first through fifth aspects, measuring the RSSI within the uplink sub-band of the SBFD resource comprises performing, in accordance with the granularity, a first RSSI measurement within a first frequency resource portion of the uplink sub-band of the SBFD resource and a second RSSI measurement within a second frequency resource portion of the uplink sub-band of the SBFD resource, or wherein measuring the RSRP within the uplink sub-band of the SBFD resource comprises performing, in accordance with the granularity, a first RSRP measurement within the first frequency resource portion of the uplink sub-band of the SBFD resource and a second RSRP measurement within the second frequency resource portion of the uplink sub-band of the SBFD resource.

In a seventh aspect, alone or in combination with one or more of the first through sixth aspects, process 1200 includes reporting an upper edge frequency resource, a center frequency resource, and a lower edge frequency resource within the uplink sub-band of the SBFD resource.

In an eighth aspect, alone or in combination with one or more of the first through seventh aspects, process 1200 includes reporting in accordance with a megahertz interval or a resource block interval within the uplink sub-band of the SBFD resource.

In a ninth aspect, alone or in combination with one or more of the first through eighth aspects, receiving the cross-link interference measurement resource configuration comprises receiving a single cross-link interference measurement resource configuration that indicates to measure the RSSI across all uplink sub-bands and all downlink sub-bands of the SBFD resource and to report a total RSSI measurement across all uplink sub-bands and all downlink sub-bands of the SBFD resource.

In a tenth aspect, alone or in combination with one or more of the first through ninth aspects, receiving the cross-link interference measurement resource configuration comprises receiving a cross-link interference measurement resource configuration that indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, and a third RSSI measurement within a first frequency resource portion of each downlink sub-band of the SBFD resource and a fourth RSSI measurement within a second frequency resource portion of each downlink sub-band of the SBFD resource, and to report the first RSSI measurement, the second RSSI measurement, the third RSSI measurement, and the fourth RSSI measurement across all uplink sub-bands and all downlink sub-bands of the SBFD resource.

In an eleventh aspect, alone or in combination with one or more of the first through tenth aspects, the uplink sub-band of the SBFD resource is configured to receive a cross-link interference measurement resource for all uplink sub-bands in any SBFD resource of a plurality of SBFD resources.

In a twelfth aspect, alone or in combination with one or more of the first through eleventh aspects, process 1200 includes obtaining a rule or a configuration that enables cross-link interference measurement resource reception within the uplink sub-band of the SBFD resource.

In a thirteenth aspect, alone or in combination with one or more of the first through twelfth aspects, process 1200 includes dropping one or more other uplink transmissions in accordance with the rule or the configuration.

In a fourteenth aspect, alone or in combination with one or more of the first through thirteenth aspects, the uplink sub-band of the SBFD resource is configured to receive a cross-link interference measurement resource for all uplink sub-bands in one or more select SBFD resources of a plurality of SBFD resources.

In a fifteenth aspect, alone or in combination with one or more of the first through fourteenth aspects, process 1200 includes obtaining a rule or configuration that enables cross-link interference measurement resource reception within the uplink sub-band of the SBFD resource without a configured sounding reference signal transmission, a configured physical uplink control channel transmission, or a higher priority uplink transmission.

In a sixteenth aspect, alone or in combination with one or more of the first through fifteenth aspects, process 1200 includes dropping one or more lower priority uplink transmissions in accordance with the rule or the configuration.

In a seventeenth aspect, alone or in combination with one or more of the first through sixteenth aspects, the SBFD resource includes an uplink sub-band that is between two other sub-bands that are outside of the uplink sub-band, and wherein the transmission by the other UE is performed within at least one other sub-band of the two other sub-bands that are outside of the uplink sub-band.

In an eighteenth aspect, alone or in combination with one or more of the first through seventeenth aspects, the two other sub-bands that are outside of the uplink sub-band are flexible sub-bands that can be used for uplink transmissions or downlink receptions.

In a nineteenth aspect, alone or in combination with one or more of the first through eighteenth aspects, measuring the RSSI within the downlink sub-band of the SBFD resource comprises measuring the RSSI within the two other sub-bands that are outside of the uplink sub-band, wherein measuring the RSSI within the uplink sub-band of the SBFD resource comprises measuring the RSSI within the two other sub-bands that are outside of the uplink sub-band, and wherein measuring the RSRP within the uplink sub-band of the SBFD resource comprises measuring the RSRP within the two other sub-bands that are outside of the uplink sub-band.

In a twentieth aspect, alone or in combination with one or more of the first through nineteenth aspects, the SBFD resource is configured on a flexible symbol or a flexible slot.

In a twenty-first aspect, alone or in combination with one or more of the first through twentieth aspects, measuring the RSSI within the downlink sub-band of the SBFD resource, the RSSI within the uplink sub-band of the SBFD resource, or the RSRP within the uplink sub-band of the SBFD resource comprises measuring the RSSI within the downlink sub-band of the SBFD resource, the RSSI within the uplink sub-band of the SBFD resource, or the RSRP within the uplink sub-band of the SBFD resource based at least in part on the cross-link interference being associated with a Layer 1, Layer 2, or Layer 3 reporting framework.

In a twenty-second aspect, alone or in combination with one or more of the first through twenty-first aspects, process 1200 includes receiving an RRC parameter that indicates whether the UE is to measure the RSSI within the downlink sub-band of the SBFD resource, the RSSI within the uplink sub-band of the SBFD resource, or the RSRP within the uplink sub-band of the SBFD resource.

In a twenty-third aspect, alone or in combination with one or more of the first through twenty-second aspects, the RRC parameter includes a bitmap, wherein each bit included in the bitmap corresponds to a sub-band of the SBFD resource or a sub-band of a plurality of SBFD resources.

In a twenty-fourth aspect, alone or in combination with one or more of the first through twenty-third aspects, the granularity is included in the RRC parameter, and wherein the granularity is based at least in part on a UE downlink bandwidth part (BWP) size or is based at least in part on the UE downlink BWP size and a downlink sub-band size for the SBFD resource.

In a twenty-fifth aspect, alone or in combination with one or more of the first through twenty-fourth aspects, process 1200 includes performing a wideband cross-link interference measurement based at least in part on not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.

In a twenty-sixth aspect, alone or in combination with one or more of the first through twenty-fifth aspects, the granularity is a frequency resource granularity.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with cross-link interference measurement.

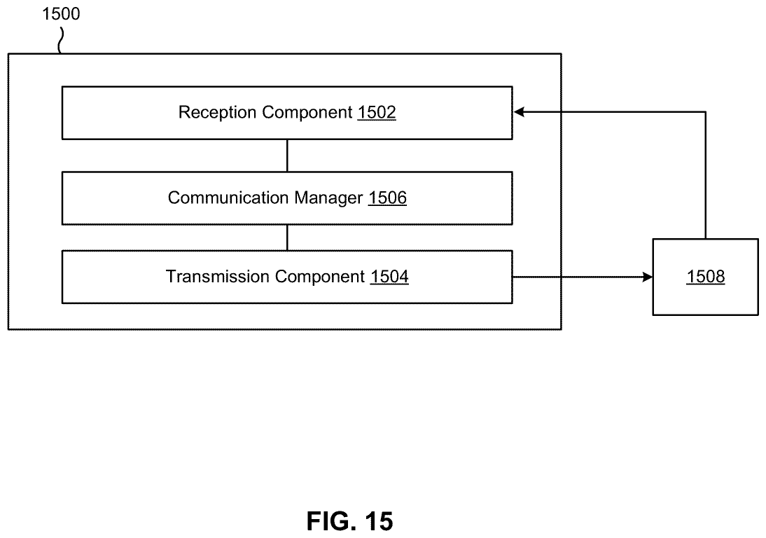

As shown in FIG. 13, in some aspects, process 1300 may include transmitting a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource (block 1310). For example, the network node (e.g., using transmission component 1504 and/or communication manager 1506, depicted in FIG. 15) may transmit a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource, as described above.

Process 1300 may include additional aspects, such as any single aspect or any combination of aspects described below and/or in connection with one or more other processes described elsewhere herein.

In a first aspect, the SBFD resource includes two downlink sub-bands and an uplink sub-band that is between the two downlink sub-bands, and wherein the cross-link interference measurement resource configuration indicates for the UE to measure the RSSI for each downlink sub-band of the SBFD resource and to report the RSSI for each downlink sub-band of the SBFD resource.

In a second aspect, alone or in combination with the first aspect, the SBFD resource includes two downlink sub-bands and an uplink sub-band that is between the two downlink sub-bands, and wherein the cross-link interference measurement resource configuration indicates for the UE to measure the RSSI across the two downlink sub-bands of the SBFD resource and to report the RSSI across the two downlink sub-bands of the SBFD resource.

In a third aspect, alone or in combination with one or more of the first and second aspects, the cross-link interference measurement resource configuration indicates for the UE to perform, in accordance with the granularity, a first RSSI measurement within a first frequency resource portion of the downlink sub-band of the SBFD resource and a second RSSI measurement within a second frequency resource portion of the downlink sub-band of the SBFD resource.

In a fourth aspect, alone or in combination with one or more of the first through third aspects, the cross-link interference measurement resource configuration further indicates for the UE to report an upper edge frequency resource, a center frequency resource, and a lower edge frequency resource within each downlink sub-band of the SBFD resource.

In a fifth aspect, alone or in combination with one or more of the first through fourth aspects, the cross-link interference measurement resource configuration further indicates for the UE to report at a megahertz interval or a resource block interval within the downlink sub-band of the SBFD resource.

In a sixth aspect, alone or in combination with one or more of the first through fifth aspects, the cross-link interference measurement resource configuration indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, or to perform, in accordance with the granularity, a first RSRP measurement within the first frequency resource portion of the uplink sub-band of the SBFD resource and a second RSRP measurement within the second frequency resource portion of the uplink sub-band of the SBFD resource.

In a seventh aspect, alone or in combination with one or more of the first through sixth aspects, the cross-link interference measurement resource configuration further indicates for the UE to report an upper edge frequency resource, a center frequency resource, and a lower edge frequency resource within the uplink sub-band of the SBFD resource.

In an eighth aspect, alone or in combination with one or more of the first through seventh aspects, the cross-link interference measurement resource configuration further indicates for the UE to report at a megahertz interval or a resource block interval within the uplink sub-band of the SBFD resource.

In a ninth aspect, alone or in combination with one or more of the first through eighth aspects, the cross-link interference measurement resource configuration is a single cross-link interference measurement resource configuration that indicates for the UE to measure the RSSI across all uplink sub-bands and all downlink sub-bands of the SBFD resource and to report a total RSSI measurement across all uplink sub-bands and all downlink sub-bands of the SBFD resource.

In a tenth aspect, alone or in combination with one or more of the first through ninth aspects, the cross-link interference measurement resource configuration indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, and a third RSSI measurement within a first frequency resource portion of each downlink sub-band of the SBFD resource and a fourth RSSI measurement within a second frequency resource portion of each downlink sub-band of the SBFD resource, and to report the first RSSI measurement, the second RSSI measurement, the third RSSI measurement, and the fourth RSSI measurement across all uplink sub-bands and all downlink sub-bands of the SBFD resource.

In an eleventh aspect, alone or in combination with one or more of the first through tenth aspects, the uplink sub-band of the SBFD resource is configured to receive a cross-link interference measurement resource for all uplink sub-bands in any SBFD resource of a plurality of SBFD resources.

In a twelfth aspect, alone or in combination with one or more of the first through eleventh aspects, process 1300 includes transmitting a rule or configuration that enables cross-link interference measurement resource reception within the uplink sub-band of the SBFD resource.

In a thirteenth aspect, alone or in combination with one or more of the first through twelfth aspects, the cross-link interference measurement resource configuration indicates for the UE to drop one or more other uplink transmissions in accordance with the rule or configuration.

In a fourteenth aspect, alone or in combination with one or more of the first through thirteenth aspects, the uplink sub-band of the SBFD resource is configured to receive a cross-link interference measurement resource for all uplink sub-bands in one or more select SBFD resources of a plurality of SBFD resources.

In a fifteenth aspect, alone or in combination with one or more of the first through fourteenth aspects, process 1300 includes transmitting a rule or configuration that enables cross-link interference measurement resource reception within the uplink sub-band of the SBFD resource without a configured sounding reference signal transmission, a configured physical uplink control channel transmission, or a higher priority uplink transmission.

In a sixteenth aspect, alone or in combination with one or more of the first through fifteenth aspects, the cross-link interference measurement resource configuration indicates for the UE to drop one or more lower priority uplink transmissions in accordance with the rule or configuration.

In a seventeenth aspect, alone or in combination with one or more of the first through sixteenth aspects, the SBFD resource includes an uplink sub-band that is between two other sub-bands that are outside of the uplink sub-band.

In an eighteenth aspect, alone or in combination with one or more of the first through seventeenth aspects, the two other sub-bands that are outside of the uplink sub-band are flexible sub-bands that can be used for uplink transmissions or downlink receptions.

In a nineteenth aspect, alone or in combination with one or more of the first through eighteenth aspects, the cross-link interference measurement resource configuration that indicates for the UE measure at least one of the RSSI within the downlink sub-band of the SBFD resource, the RSSI within the uplink sub-band of the SBFD resource, or the RSRP within the uplink sub-band of the SBFD resource, indicates for the UE to measure the RSSI within the two other sub-bands that are outside of the uplink sub-band or to measure the RSRP within the two other sub-bands that are outside of the uplink sub-band.

In a twentieth aspect, alone or in combination with one or more of the first through nineteenth aspects, the SBFD resource is configured on a flexible symbol or a flexible slot.

In a twenty-first aspect, alone or in combination with one or more of the first through twentieth aspects, the cross-link interference measurement resource configuration that indicates for the UE measure at least one of the RSSI within the downlink sub-band of the SBFD resource, the RSSI within the uplink sub-band of the SBFD resource, or the RSRP within the uplink sub-band of the SBFD resource, indicates for the UE to measure the RSSI within the downlink sub-band of the SBFD resource, the RSSI within the uplink sub-band of the SBFD resource, or the RSRP within the uplink sub-band of the SBFD resource based at least in part on cross-link interference associated with a Layer 1, Layer 2, or Layer 3 reporting framework.

In a twenty-second aspect, alone or in combination with one or more of the first through twenty-first aspects, process 1300 includes transmitting an RRC parameter that indicates whether the UE is to measure the RSSI within the downlink sub-band of the SBFD resource, the RSSI within the uplink sub-band of the SBFD resource, or the RSRP within the uplink sub-band of the SBFD resource.

In a twenty-third aspect, alone or in combination with one or more of the first through twenty-second aspects, the RRC parameter includes a bitmap, wherein each bit included in the bitmap corresponds to a sub-band of the SBFD resource or a sub-band of a plurality of SBFD resources.

In a twenty-fourth aspect, alone or in combination with one or more of the first through twenty-third aspects, the granularity is included in the RRC parameter, and wherein the granularity is based at least in part on a UE downlink bandwidth part (BWP) size or is based at least in part on the UE downlink BWP size and a downlink sub-band size for the SBFD resource.

In a twenty-fifth aspect, alone or in combination with one or more of the first through twenty-fourth aspects, the cross-link interference measurement resource configuration indicates for the UE to perform a wideband cross-link interference measurement based at least in part on the UE not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.

In a twenty-sixth aspect, alone or in combination with one or more of the first through twenty-fifth aspects, the granularity is a frequency resource granularity.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a cross-link interference measurement resource configuration that indicates a granularity for measuring one or more reference signals. The reception component 1402 may receive cross-link interference associated with a transmission by another UE within an uplink sub-band of an SBFD resource. The communication manager 1406 may measure, in accordance with the granularity, at least one of an RSSI within a downlink sub-band of the SBFD resource, an RSSI within an uplink sub-band of the SBFD resource, or an RSRP within the uplink sub-band of the SBFD resource.

The communication manager 1406 may report an upper edge frequency resource, a center frequency resource, and a lower edge frequency resource within each downlink sub-band of the SBFD resource. The communication manager 1406 may report in accordance with a megahertz interval or a resource block interval within the downlink sub-band of the SBFD resource. The communication manager 1406 may report an upper edge frequency resource, a center frequency resource, and a lower edge frequency resource within the uplink sub-band of the SBFD resource. The communication manager 1406 may report in accordance with a megahertz interval or a resource block interval within the uplink sub-band of the SBFD resource. The reception component 1402 may obtain a rule or a configuration that enables cross-link interference measurement resource reception within the uplink sub-band of the SBFD resource. The communication manager 1406 may drop one or more other uplink transmissions in accordance with the rule or the configuration. The reception component 1402 may obtain a rule or configuration that enables cross-link interference measurement resource reception within the uplink sub-band of the SBFD resource without a configured sounding reference signal transmission, a configured physical uplink control channel transmission, or a higher priority uplink transmission. The communication manager 1406 may drop one or more lower priority uplink transmissions in accordance with the rule or the configuration. The reception component 1402 may receive an RRC parameter that indicates whether the UE is to measure the RSSI within the downlink sub-band of the SBFD resource, the RSSI within the uplink sub-band of the SBFD resource, or the RSRP within the uplink sub-band of the SBFD resource. The communication manager 1406 may perform a wideband cross-link interference measurement based at least in part on not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a cross-link interference measurement resource configuration that indicates a granularity for measuring one or more reference signals and that indicates for a UE to measure, in accordance with the granularity, at least one of an RSSI within a downlink sub-band of an SBFD resource, an RSSI within an uplink sub-band of the SBFD resource, or an RSRP within the uplink sub-band of the SBFD resource.

The transmission component 1504 may transmit a rule or configuration that enables cross-link interference measurement resource reception within the uplink sub-band of the SBFD resource.

The transmission component 1504 may transmit a rule or configuration that enables cross-link interference measurement resource reception within the uplink sub-band of the SBFD resource without a configured sounding reference signal transmission, a configured physical uplink control channel transmission, or a higher priority uplink transmission.

The transmission component 1504 may transmit an RRC parameter that indicates whether the UE is to measure the RSSI within the downlink sub-band of the SBFD resource, the RSSI within the uplink sub-band of the SBFD resource, or the RSRP within the uplink sub-band of the SBFD resource.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a user equipment (UE), comprising: receiving a cross-link interference measurement resource configuration that indicates a granularity for measuring one or more reference signals; receiving cross-link interference associated with a transmission by another UE within an uplink sub-band of a sub-band full-duplex (SBFD) resource; and measuring, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource.
Aspect 2: The method of Aspect 1, wherein the SBFD resource includes two downlink sub-bands and an uplink sub-band that is between the two downlink sub-bands, wherein measuring the RSSI within the downlink sub-band of the SBFD resource comprises measuring the RSSI for each downlink sub-band of the SBFD resource, and wherein the method further comprises reporting the RSSI for each downlink sub-band of the SBFD resource.
Aspect 3: The method of any of Aspects 1-2, wherein the SBFD resource includes two downlink sub-bands and an uplink sub-band that is between the two downlink sub-bands, wherein measuring the RSSI within the downlink sub-band of the SBFD resource comprises measuring the RSSI across the two downlink sub-bands of the SBFD resource, and wherein the method further comprises reporting the RSSI across the two downlink sub-bands of the SBFD resource.
Aspect 4: The method of any of Aspects 1-3, wherein measuring the RSSI within the downlink sub-band of the SBFD resource comprises performing, in accordance with the granularity, a first RSSI measurement within a first frequency resource portion of the downlink sub-band of the SBFD resource and a second RSSI measurement within a second frequency resource portion of the downlink sub-band of the SBFD resource.
Aspect 5: The method of Aspect 4, further comprising reporting an upper edge frequency resource, a center frequency resource, and a lower edge frequency resource within each downlink sub-band of the SBFD resource.
Aspect 6: The method of Aspect 4, further comprising reporting in accordance with a megahertz interval or a resource block interval within the downlink sub-band of the SBFD resource.
Aspect 7: The method of any of Aspects 1-6, wherein measuring the RSSI within the uplink sub-band of the SBFD resource comprises performing, in accordance with the granularity, a first RSSI measurement within a first frequency resource portion of the uplink sub-band of the SBFD resource and a second RSSI measurement within a second frequency resource portion of the uplink sub-band of the SBFD resource, or wherein measuring the RSRP within the uplink sub-band of the SBFD resource comprises performing, in accordance with the granularity, a first RSRP measurement within the first frequency resource portion of the uplink sub-band of the SBFD resource and a second RSRP measurement within the second frequency resource portion of the uplink sub-band of the SBFD resource.
Aspect 8: The method of Aspect 7, further comprising reporting an upper edge frequency resource, a center frequency resource, and a lower edge frequency resource within the uplink sub-band of the SBFD resource.
Aspect 9: The method of Aspect 7, further comprising reporting in accordance with a megahertz interval or a resource block interval within the uplink sub-band of the SBFD resource.
Aspect 10: The method of any of Aspects 1-9, wherein receiving the cross-link interference measurement resource configuration comprises receiving a single cross-link interference measurement resource configuration that indicates to measure the RSSI across all uplink sub-bands and all downlink sub-bands of the SBFD resource and to report a total RSSI measurement across all uplink sub-bands and all downlink sub-bands of the SBFD resource.
Aspect 11: The method of any of Aspects 1-10, wherein receiving the cross-link interference measurement resource configuration comprises receiving a cross-link interference measurement resource configuration that indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, and a third RSSI measurement within a first frequency resource portion of each downlink sub-band of the SBFD resource and a fourth RSSI measurement within a second frequency resource portion of each downlink sub-band of the SBFD resource, and to report the first RSSI measurement, the second RSSI measurement, the third RSSI measurement, and the fourth RSSI measurement across all uplink sub-bands and all downlink sub-bands of the SBFD resource.
Aspect 12: The method of any of Aspects 1-11, wherein the uplink sub-band of the SBFD resource is configured to receive a cross-link interference measurement resource for all uplink sub-bands in any SBFD resource of a plurality of SBFD resources.
Aspect 13: The method of Aspect 12, further comprising obtaining a rule or a configuration that enables cross-link interference measurement resource reception within the uplink sub-band of the SBFD resource.
Aspect 14: The method of Aspect 13, further comprising dropping one or more other uplink transmissions in accordance with the rule or the configuration.
Aspect 15: The method of any of Aspects 1-14, wherein the uplink sub-band of the SBFD resource is configured to receive a cross-link interference measurement resource for all uplink sub-bands in one or more select SBFD resources of a plurality of SBFD resources.
Aspect 16: The method of Aspect 15, further comprising obtaining a rule or configuration that enables cross-link interference measurement resource reception within the uplink sub-band of the SBFD resource without a configured sounding reference signal transmission, a configured physical uplink control channel transmission, or a higher priority uplink transmission.
Aspect 17: The method of Aspect 16, further comprising dropping one or more lower priority uplink transmissions in accordance with the rule or the configuration.
Aspect 18: The method of any of Aspects 1-17, wherein the SBFD resource includes an uplink sub-band that is between two other sub-bands that are outside of the uplink sub-band, and wherein the transmission by the other UE is performed within at least one other sub-band of the two other sub-bands that are outside of the uplink sub-band.
Aspect 19: The method of Aspect 18, wherein the two other sub-bands that are outside of the uplink sub-band are flexible sub-bands that can be used for uplink transmissions or downlink receptions.
Aspect 20: The method of Aspect 18, wherein measuring the RSSI within the downlink sub-band of the SBFD resource comprises measuring the RSSI within the two other sub-bands that are outside of the uplink sub-band, wherein measuring the RSSI within the uplink sub-band of the SBFD resource comprises measuring the RSSI within the two other sub-bands that are outside of the uplink sub-band, and wherein measuring the RSRP within the uplink sub-band of the SBFD resource comprises measuring the RSRP within the two other sub-bands that are outside of the uplink sub-band.
Aspect 21: The method of Aspect 18, wherein the SBFD resource is configured on a flexible symbol or a flexible slot.
Aspect 22: The method of any of Aspects 1-21, wherein measuring the RSSI within the downlink sub-band of the SBFD resource, the RSSI within the uplink sub-band of the SBFD resource, or the RSRP within the uplink sub-band of the SBFD resource comprises measuring the RSSI within the downlink sub-band of the SBFD resource, the RSSI within the uplink sub-band of the SBFD resource, or the RSRP within the uplink sub-band of the SBFD resource based at least in part on the cross-link interference being associated with a Layer 1, Layer 2, or Layer 3 reporting framework.
Aspect 23: The method of Aspect 22, further comprising receiving a radio resource control (RRC) parameter that indicates whether the UE is to measure the RSSI within the downlink sub-band of the SBFD resource, the RSSI within the uplink sub-band of the SBFD resource, or the RSRP within the uplink sub-band of the SBFD resource.
Aspect 24: The method of Aspect 23, wherein the RRC parameter includes a bitmap, wherein each bit included in the bitmap corresponds to a sub-band of the SBFD resource or a sub-band of a plurality of SBFD resources.
Aspect 25: The method of Aspect 23, wherein the granularity is included in the RRC parameter, and wherein the granularity is based at least in part on a UE downlink bandwidth part (BWP) size or is based at least in part on the UE downlink BWP size and a downlink sub-band size for the SBFD resource.
Aspect 26: The method of any of Aspects 1-25, further comprising performing a wideband cross-link interference measurement based at least in part on not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.
Aspect 27: The method of any of Aspects 1-26, wherein the granularity is a frequency resource granularity.
Aspect 28: A method of wireless communication performed by a network node, comprising: transmitting a cross-link interference measurement resource configuration that indicates a granularity for measuring one or more reference signals and that indicates for a user equipment (UE) to measure, in accordance with the granularity, at least one of a reference signal strength indicator (RSSI) within a downlink sub-band of an SBFD resource, an RSSI within an uplink sub-band of the SBFD resource, or a reference signal received power (RSRP) within the uplink sub-band of the SBFD resource.
Aspect 29: The method of Aspect 28, wherein the SBFD resource includes two downlink sub-bands and an uplink sub-band that is between the two downlink sub-bands, and wherein the cross-link interference measurement resource configuration indicates for the UE to measure the RSSI for each downlink sub-band of the SBFD resource and to report the RSSI for each downlink sub-band of the SBFD resource.
Aspect 30: The method of any of Aspects 28-29, wherein the SBFD resource includes two downlink sub-bands and an uplink sub-band that is between the two downlink sub-bands, and wherein the cross-link interference measurement resource configuration indicates for the UE to measure the RSSI across the two downlink sub-bands of the SBFD resource and to report the RSSI across the two downlink sub-bands of the SBFD resource.
Aspect 31: The method of any of Aspects 28-30, wherein the cross-link interference measurement resource configuration indicates for the UE to perform, in accordance with the granularity, a first RSSI measurement within a first frequency resource portion of the downlink sub-band of the SBFD resource and a second RSSI measurement within a second frequency resource portion of the downlink sub-band of the SBFD resource.
Aspect 32: The method of Aspect 31, wherein the cross-link interference measurement resource configuration further indicates for the UE to report an upper edge frequency resource, a center frequency resource, and a lower edge frequency resource within each downlink sub-band of the SBFD resource.
Aspect 33: The method of Aspect 31, wherein the cross-link interference measurement resource configuration further indicates for the UE to report at a megahertz interval or a resource block interval within the downlink sub-band of the SBFD resource.
Aspect 34: The method of any of Aspects 28-33, wherein the cross-link interference measurement resource configuration indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, or to perform, in accordance with the granularity, a first RSRP measurement within the first frequency resource portion of the uplink sub-band of the SBFD resource and a second RSRP measurement within the second frequency resource portion of the uplink sub-band of the SBFD resource.
Aspect 35: The method of Aspect 34, wherein the cross-link interference measurement resource configuration further indicates for the UE to report an upper edge frequency resource, a center frequency resource, and a lower edge frequency resource within the uplink sub-band of the SBFD resource.
Aspect 36: The method of Aspect 34, wherein the cross-link interference measurement resource configuration further indicates for the UE to report at a megahertz interval or a resource block interval within the uplink sub-band of the SBFD resource.
Aspect 37: The method of any of Aspects 28-36, wherein the cross-link interference measurement resource configuration is a single cross-link interference measurement resource configuration that indicates for the UE to measure the RSSI across all uplink sub-bands and all downlink sub-bands of the SBFD resource and to report a total RSSI measurement across all uplink sub-bands and all downlink sub-bands of the SBFD resource.
Aspect 38: The method of any of Aspects 28-37, wherein the cross-link interference measurement resource configuration indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, and a third RSSI measurement within a first frequency resource portion of each downlink sub-band of the SBFD resource and a fourth RSSI measurement within a second frequency resource portion of each downlink sub-band of the SBFD resource, and to report the first RSSI measurement, the second RSSI measurement, the third RSSI measurement, and the fourth RSSI measurement across all uplink sub-bands and all downlink sub-bands of the SBFD resource.
Aspect 39: The method of any of Aspects 28-38, wherein the uplink sub-band of the SBFD resource is configured to receive a cross-link interference measurement resource for all uplink sub-bands in any SBFD resource of a plurality of SBFD resources.
Aspect 40: The method of Aspect 39, further comprising transmitting a rule or configuration that enables cross-link interference measurement resource reception within the uplink sub-band of the SBFD resource.
Aspect 41: The method of Aspect 40, wherein the cross-link interference measurement resource configuration indicates for the UE to drop one or more other uplink transmissions in accordance with the rule or configuration.
Aspect 42: The method of any of Aspects 28-41, wherein the uplink sub-band of the SBFD resource is configured to receive a cross-link interference measurement resource for all uplink sub-bands in one or more select SBFD resources of a plurality of SBFD resources.
Aspect 43: The method of Aspect 42, further comprising transmitting a rule or configuration that enables cross-link interference measurement resource reception within the uplink sub-band of the SBFD resource without a configured sounding reference signal transmission, a configured physical uplink control channel transmission, or a higher priority uplink transmission.
Aspect 44: The method of Aspect 43, wherein the cross-link interference measurement resource configuration indicates for the UE to drop one or more lower priority uplink transmissions in accordance with the rule or configuration.
Aspect 45: The method of any of Aspects 28-44, wherein the SBFD resource includes an uplink sub-band that is between two other sub-bands that are outside of the uplink sub-band.
Aspect 46: The method of Aspect 45, wherein the two other sub-bands that are outside of the uplink sub-band are flexible sub-bands that can be used for uplink transmissions or downlink receptions.
Aspect 47: The method of Aspect 45, wherein the cross-link interference measurement resource configuration that indicates for the UE measure at least one of the RSSI within the downlink sub-band of the SBFD resource, the RSSI within the uplink sub-band of the SBFD resource, or the RSRP within the uplink sub-band of the SBFD resource, indicates for the UE to measure the RSSI within the two other sub-bands that are outside of the uplink sub-band or to measure the RSRP within the two other sub-bands that are outside of the uplink sub-band.
Aspect 48: The method of any of Aspects 28-47, wherein the SBFD resource is configured on a flexible symbol or a flexible slot.
Aspect 49: The method of any of Aspects 28-48, wherein the cross-link interference measurement resource configuration that indicates for the UE measure at least one of the RSSI within the downlink sub-band of the SBFD resource, the RSSI within the uplink sub-band of the SBFD resource, or the RSRP within the uplink sub-band of the SBFD resource, indicates for the UE to measure the RSSI within the downlink sub-band of the SBFD resource, the RSSI within the uplink sub-band of the SBFD resource, or the RSRP within the uplink sub-band of the SBFD resource based at least in part on cross-link interference associated with a Layer 1, Layer 2, or Layer 3 reporting framework.
Aspect 50: The method of any of Aspects 28-49, further comprising transmitting a radio resource control (RRC) parameter that indicates whether the UE is to measure the RSSI within the downlink sub-band of the SBFD resource, the RSSI within the uplink sub-band of the SBFD resource, or the RSRP within the uplink sub-band of the SBFD resource.
Aspect 51: The method of Aspect 50, wherein the RRC parameter includes a bitmap, wherein each bit included in the bitmap corresponds to a sub-band of the SBFD resource or a sub-band of a plurality of SBFD resources.
Aspect 52: The method of Aspect 50, wherein the granularity is included in the RRC parameter, and wherein the granularity is based at least in part on a UE downlink bandwidth part (BWP) size or is based at least in part on the UE downlink BWP size and a downlink sub-band size for the SBFD resource.
Aspect 53: The method of any of Aspects 28-52, wherein the cross-link interference measurement resource configuration indicates for the UE to perform a wideband cross-link interference measurement based at least in part on the UE not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.
Aspect 54: The method of any of Aspects 28-53, wherein the granularity is a frequency resource granularity.
Aspect 55: An apparatus for wireless communication at a device, comprising a processor; memory coupled with the processor; and instructions stored in the memory and executable by the processor to cause the apparatus to perform the method of one or more of Aspects 1-54.
Aspect 56: A device for wireless communication, comprising a memory and one or more processors coupled to the memory, the one or more processors configured to perform the method of one or more of Aspects 1-54.
Aspect 57: An apparatus for wireless communication, comprising at least one means for performing the method of one or more of Aspects 1-54.
Aspect 58: A non-transitory computer-readable medium storing code for wireless communication, the code comprising instructions executable by a processor to perform the method of one or more of Aspects 1-54.
Aspect 59: A non-transitory computer-readable medium storing a set of instructions for wireless communication, the set of instructions comprising one or more instructions that, when executed by one or more processors of a device, cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a cross-link interference measurement resource configuration that indicates a granularity for measuring one or more reference signals;
receive cross-link interference associated with a transmission by another UE within an uplink sub-band of a sub-band full-duplex (SBFD) resource; and
measure, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource.

2. The apparatus of claim 1, wherein the SBFD resource includes two downlink sub-bands and an uplink sub-band that is between the two downlink sub-bands, wherein measuring the RSSI within the downlink sub-band of the SBFD resource comprises measuring the RSSI for each downlink sub-band of the SBFD resource, and wherein the one or more processors are further configured to report the RSSI for each downlink sub-band of the SBFD resource.

3. The apparatus of claim 1, wherein the SBFD resource includes two downlink sub-bands and an uplink sub-band that is between the two downlink sub-bands, wherein measuring the RSSI within the downlink sub-band of the SBFD resource comprises measuring the RSSI across the two downlink sub-bands of the SBFD resource, and wherein the one or more processors are further configured to report the RSSI across the two downlink sub-bands of the SBFD resource.

4. The apparatus of claim 1, wherein the one or more processors, to measure the RSSI within the downlink sub-band of the SBFD resource, are configured to perform, in accordance with the granularity, a first RSSI measurement within a first frequency resource portion of the downlink sub-band of the SBFD resource and a second RSSI measurement within a second frequency resource portion of the downlink sub-band of the SBFD resource.

5. The apparatus of claim 1, wherein measuring the RSSI within the uplink sub-band of the SBFD resource comprises performing, in accordance with the granularity, a first RSSI measurement within a first frequency resource portion of the uplink sub-band of the SBFD resource and a second RSSI measurement within a second frequency resource portion of the uplink sub-band of the SBFD resource, or wherein measuring the RSRP within the uplink sub-band of the SBFD resource comprises performing, in accordance with the granularity, a first RSRP measurement within the first frequency resource portion of the uplink sub-band of the SBFD resource and a second RSRP measurement within the second frequency resource portion of the uplink sub-band of the SBFD resource.

6. The apparatus of claim 1, wherein the one or more processors, to receive the cross-link interference measurement resource configuration, are configured to receive a single cross-link interference measurement resource configuration that indicates to measure the RSSI across all uplink sub-bands and all downlink sub-bands of the SBFD resource and to report a total RSSI measurement across all uplink sub-bands and all downlink sub-bands of the SBFD resource.

7. The apparatus of claim 1, wherein the one or more processors, to receive the cross-link interference measurement resource configuration, are configured to receive a cross-link interference measurement resource configuration that indicates for the UE to perform, in accordance with the granularity, a first RSSI measurement within a first frequency resource portion of the uplink sub-band of the SBFD resource and a second RSSI measurement within a second frequency resource portion of the uplink sub-band of the SBFD resource, and a third RSSI measurement within a first frequency resource portion of each downlink sub-band of the SBFD resource and a fourth RSSI measurement within a second frequency resource portion of each downlink sub-band of the SBFD resource, and to report the first RSSI measurement, the second RSSI measurement, the third RSSI measurement, and the fourth RSSI measurement across all uplink sub-bands and all downlink sub-bands of the SBFD resource.

8. The apparatus of claim 1, wherein the one or more processors are further configured to receive a cross-link interference measurement resource for all uplink sub-bands in any SBFD resource of a plurality of SBFD resources.

9. The apparatus of claim 8, wherein the one or more processors are further configured to obtain a rule or a configuration that enables cross-link interference measurement resource reception within the uplink sub-band of the SBFD resource.

10. The apparatus of claim 9, wherein the one or more processors are further configured to drop one or more other uplink transmissions in accordance with the rule or the configuration.

11. The apparatus of claim 1, wherein the one or more processors are further configured to receive a cross-link interference measurement resource for all uplink sub-bands in one or more select SBFD resources of a plurality of SBFD resources.

12. The apparatus of claim 11, wherein the one or more processors are further configured to obtain a rule or configuration that enables cross-link interference measurement resource reception within the uplink sub-band of the SBFD resource without a configured sounding reference signal transmission, a configured physical uplink control channel transmission, or a higher priority uplink transmission.

13. The apparatus of claim 12, wherein the one or more processors are further configured to drop one or more lower priority uplink transmissions in accordance with the rule or the configuration.

14. The apparatus of claim 1, wherein the SBFD resource includes an uplink sub-band that is between two other sub-bands that are outside of the uplink sub-band, and wherein the transmission by the other UE is performed within at least one other sub-band of the two other sub-bands that are outside of the uplink sub-band.

15. The apparatus of claim 14, wherein the two other sub-bands that are outside of the uplink sub-band are flexible sub-bands that can be used for uplink transmissions or downlink receptions.

16. The apparatus of claim 1, wherein the one or more processors, to measure the RSSI within the downlink sub-band of the SBFD resource, the RSSI within the uplink sub-band of the SBFD resource, or the RSRP within the uplink sub-band of the SBFD resource, are configured to measure the RSSI within the downlink sub-band of the SBFD resource, the RSSI within the uplink sub-band of the SBFD resource, or the RSRP within the uplink sub-band of the SBFD resource based at least in part on the cross-link interference being associated with a Layer 1, Layer 2, or Layer 3 reporting framework.

17. The apparatus of claim 16, wherein the one or more processors are further configured to receive a radio resource control (RRC) parameter that indicates whether the UE is to measure the RSSI within the downlink sub-band of the SBFD resource, the RSSI within the uplink sub-band of the SBFD resource, or the RSRP within the uplink sub-band of the SBFD resource.

18. The apparatus of claim 1, wherein the one or more processors are further configured to perform a wideband cross-link interference measurement based at least in part on not being configured with a radio resource control parameter that indicates whether the UE is to measure the RSSI within the downlink sub-band of the SBFD resource, the RSSI within the uplink sub-band of the SBFD resource, or the RSRP within the uplink sub-band of the SBFD resource.

19. An apparatus for wireless communication at a network node, comprising:
a memory; and
one or more processors, coupled to the memory, configured to:
transmit a cross-link interference measurement resource configuration that indicates a granularity for measuring one or more reference signals and that indicates for a user equipment (UE) to measure, in accordance with the granularity, at least one of a reference signal strength indicator (RSSI) within a downlink sub-band of a sub-band full-duplex (SBFD) resource, an RSSI within an uplink sub-band of the SBFD resource, or a reference signal received power (RSRP) within the uplink sub-band of the SBFD resource.

20. A method of wireless communication performed by a user equipment (UE), comprising:
receiving a cross-link interference measurement resource configuration that indicates a granularity for measuring one or more reference signals;
receiving cross-link interference associated with a transmission by another UE within an uplink sub-band of a sub-band full-duplex (SBFD) resource; and
measuring, in accordance with the granularity, at least one of a reference signal strength indicator (RSSI) within a downlink sub-band of the SBFD resource, an RSSI within an uplink sub-band of the SBFD resource, or a reference signal received power (RSRP) within the uplink sub-band of the SBFD resource.
